(19) United States
(12) Patent Application Publication
(10) Pub. No.: US 2020/0290476 A1
(43) Pub. Date: Sep. 17, 2020

(54) METHOD FOR CHARGING A BATTERY OF A VEHICLE

(71) Applicant: AUDI AG, Ingolstadt (DE)

(72) Inventor: Tobias BROK, Kosching (DE)

(73) Assignee: AUDI AG, Ingolstadt (DE)

(21) Appl. No.: 16/803,014

(22) Filed: Feb. 27, 2020

(30) Foreign Application Priority Data
Mar. 13, 2019 (DE) 102019203390.3

(51) Int. Cl. B60L 53/66; B60L 53/12; B60L 53/18; H02J 50/80; H02J 7/00

(52) U.S. Cl. CPC B60L 53/66; B60L 53/12; B60L 53/18; H02J 2310/48; H02J 7/00034; B60L 2250/10; H02J 50/80

(57) ABSTRACT

A method for charging a battery of a vehicle using a charging station, wherein the charging station includes an electric power source and a data source, wherein an output device which is configured for issuing acoustic signals is arranged in an interior of the vehicle, wherein a first connection for transferring electric power is provided between the power source of the charging station and the battery of the vehicle, wherein a second connection for transferring data is provided between the data source of the charging station and the output device in the vehicle, wherein the electric power is transferred via the first connection from the power source to the battery, and wherein data for acoustic signals is transferred via the second connection from the data source to the output device, wherein the output device issues acoustic signals based on the data received.

### FIELD

The disclosure relates to a method for charging a battery of a vehicle and to a system for charging a battery of a vehicle.

### BACKGROUND

For charging a battery of a vehicle, said battery must be connected to a power source of a charging station. A charging process that can be performed may take several minutes. During charging, a time of a driver of the vehicle should be used wisely by providing the driver with information and the like.

Document US 2011/204847 A1 describes an advertising system for a charging station for an electric vehicle.

A charging station for an electric vehicle having an advertising terminal is known from document CN 101728593 A.

A vending system for electric power for an electric or hybrid vehicle is described in document US 2013/035786 A1.

Furthermore, it is known from document DE 10 2011 056 651 A1 that a charging device for an electric vehicle comprises a computer column and at least one charge control module with an outlet.

### SUMMARY

Before this background, it was an object to provide a design of a charging process for charging a battery of a vehicle, which process is beneficial for the driver.

This problem is solved by a method and system having the features of the independent claims. Embodiments of the method and system can be derived from the dependent claims.

The method according to the disclosure is intended for charging a battery of a vehicle using a charging station, wherein the charging station comprises or includes an electric power source and a data source, wherein the vehicle comprises the battery, wherein an output device which is configured for issuing acoustic signals is arranged in an interior of the vehicle. In this method, a first connection for transferring electric power is provided between the power source of the charging station and the battery of the electric vehicle and a second connection for transferring data is provided between the data source of the charging station and the output device in the vehicle. In addition, the electric power is transferred via the first connection from the power source to the battery. Substantially synchronously or at the same time, data for acoustic signals is transferred via the second connection from the data source to the output device in the interior, wherein the output device issues acoustic signals into the interior of the vehicle based on the data received, which signals can be heard by a driver as the occupant of the vehicle.

It is possible that the acoustic data and/or signals include information on a charging process, for example a progress or a remaining duration of the charging process, for charging the battery with electric power.

An output device may be used which comprises or includes at least one speaker and/or at least one sound source configured to convert and/or transform the data for the acoustic signals into the acoustic signals. It is possible that the output device is permanently arranged or installed in the vehicle. But it is also conceivable that a portable and/or mobile data processing and/or communication device is used as the output device, which is temporarily arranged in the interior of the vehicle and can be removed, and is for example configured as a mobile phone, a cell phone, or a smart phone, wherein such an output device can also be used separately from the vehicle.

The data for the acoustic signals can be transferred to the output device via a data line and/or radio, e.g. Bluetooth, WLAN, or Wi-Fi, or a mobile phone connection.

Furthermore, electric power can be transferred to the battery of the vehicle via an electric power line and/or by induction.

In an embodiment, a cable is used which comprises or includes the data line and the electric power line.

Using the method, additional data for visual signals can be transferred via the second connection from the data source to the output device, wherein a monitor or screen or display of the output device issues optical signals into the interior of the vehicle based on the data received, wherein the optical data and/or signals may include information on the charging process.

The system according to the disclosure is configured for charging a battery of a vehicle, wherein the system comprises a charging station and an output device, wherein the charging station comprises or includes an electric power source and a data source, wherein the vehicle comprises the battery, wherein an output device which is configured for issuing acoustic signals can be or is at least non-permanently or temporarily arranged in an interior of the vehicle. A first connection for transferring electric power can or must be provided between the power source of the charging station and the battery of the electric vehicle, wherein a second connection for transferring data can or must be provided between the data source of the charging station and the output device in the vehicle. The first connection is configured to transfer electric power from the power source to the battery. The second connection is configured to transfer data for acoustic signals substantially synchronously or at the same time from the data source to the output device arranged in the interior, wherein the output device is configured to output, e.g. to transmit and/or broadcast, acoustic signals into the interior of the vehicle based on the data received.

The presented charging station as part of the system is configured for charging the battery of the vehicle, wherein the vehicle comprises at least on electric machine which is supplied with electric power from the battery of the vehicle, which electric power the electric machine converts into mechanical energy, wherein the vehicle is driven or propelled by said mechanical energy. The battery of the vehicle can also be described and/or configured as a traction battery. The vehicle can also be configured and/or described as an electric vehicle or hybrid vehicle.

During the charging process for charging the battery, the data for the acoustic signals and optionally for the visual or optical signals is additionally provided to the output device arranged in the interior of the vehicle and displayed to the driver in the interior of the vehicle during a period of time, e.g. waiting time, for the charging process. This means that sound information can be displayed as acoustic signals and image information can be displayed as optical signals to the driver. Contents of this acoustic sound information and optical image information include, for example, commercials, music, news, but also information about the currently performed charging process of the battery. Such information on the charging process can be acoustically transferred either cyclically or depending on the situation. Such information includes for example a status of the charging process or an error that may have occurred during the charging process. The driver as the customer can also be presented with a full-fledged program, which may include, for example, commercials or movies in addition to news. The driver as the customer, or an advertiser, can be charged for acoustic and/or optical content delivered and/or provided in the process, for example by means of an invoice for the electric power provided in the charging process.

It is envisaged that the data for the acoustic signals and optionally the optical signals is transferred to the output device in the interior of the vehicle, wherein the output device is at least during the charging process arranged in the interior of the vehicle if the output device is for example configured as a mobile phone or portable computer. But it is also possible that the output device is firmly installed and thus permanently arranged in the interior. The data transfer is then performed using a cable to be configured and/or described as a charging cable, which includes a line serving as a connection for wired data transfer in addition to a line serving as a connection for electric power. However, transfer of the data via electromagnetic waves is also conceivable as a connection, wherein Bluetooth, Wi-Fi or WLAN, or a FM DAB transmitter, for example, is used for sending, transmitting and/or receiving the data.

It will be appreciated that the features mentioned above and the features to be explained below cannot just be used in the combination described but in any other combination or by themselves, without deviating from the scope of the present disclosure.

### BRIEF DESCRIPTION OF THE DRAWINGS

The disclosure is schematically represented in the drawings based on embodiments thereof and will be described schematically and in detail with reference to the drawings.

FIG. 1 is a schematic view of an embodiment of the system according to the disclosure for performing an embodiment of the method according to the disclosure.

### DETAILED DESCRIPTION

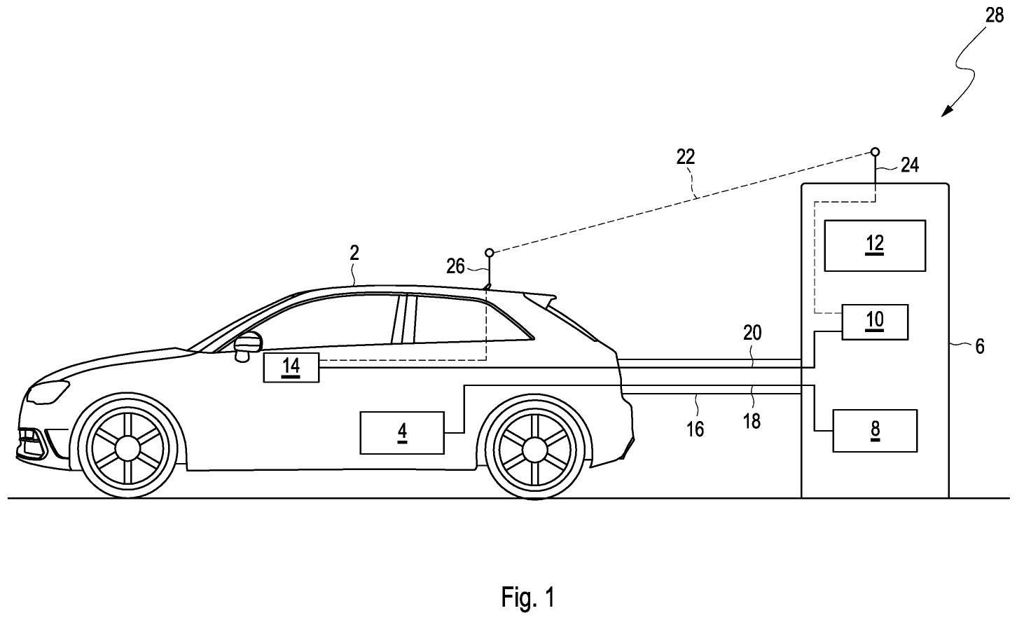

FIG. 1 shows a schematic view of an electrically driven vehicle 2, which may also be configured and/or described as an electric motor vehicle or car. The vehicle 2 comprises a battery 4, a so-called traction battery, to supply an electric machine thereof.

FIG. 1 also shows a charging station 6, which comprises an electric power source 8 and a data source 10. The charging station 6 further comprises an output module 12 having a monitor and a speaker for the visual and acoustic display of signals. FIG. 1 also shows that an output device 14 is arranged in an interior of the vehicle 2, which may also be configured and/or described as a display device. The charging column 6 and its components and at least the output device 14 in the vehicle 2 are configured as components of the embodiment of the system 28 according to the disclosure.

When performing an embodiment of the method according to the disclosure, the vehicle 2 is connected to the charging station 6 via a cable 16, e.g. a charging cable. This cable 16 includes on the one hand the connection 18, which herein is configured as a line, and a second connection 20, which likewise is configured as a line. The battery 4 is connected to the power source 8 of the charging station 6 via the first connection 18. The output device 14, which is arranged in the interior of the vehicle 2, is further connected to the data source 10 of the charging station 6 via a second connection 20.

In the embodiment of the method, electric power is transferred from the power source 8 via the first connection 18 to the battery 4 in order to perform a charging process of the battery 4. Meanwhile and in addition, data is transferred from the data source 10 via the second connection 20 to the output device 14. This data includes data for acoustic signals and optionally data for optical signals. Said data is received by the output device 14. Furthermore, the output device 14 converts, generates, and/or provides acoustic signals from the data for the acoustic signals and transmits them via a speaker into the interior of the vehicle 2. Accordingly, the output device 14 can convert the data for the optical signals into the optical signals and displayed by or on a monitor, screen, or display of the output device 14.

The output device 14 is typically permanently installed in the interior of the vehicle 2. If the output device 14 is permanently installed, the data for the acoustic and optionally optical signals may not be transferred via the first connection 20, which herein is configured as a wired connection, but transferred wirelessly via an alternative or complementary second connection 22 using electromagnetic waves or radio. The charging station 6 additionally comprises an antenna 24 to this end. Accordingly, the output device 14 is also connected to an antenna 26, in this case to an antenna 26 of the vehicle 2. Data is transferred between the two antennas 24, 26 and thus between the data source 10 and the output device 14.

In another alternative embodiment, the output device 14 can be configured as a mobile or portable output device 14, such as a mobile phone or a smartphone, which in the embodiment of the method according to the disclosure is arranged at least during the charging process in the interior of the vehicle 2. In this case, the antenna 26 is configured as the antenna 26 of said portable output device 14 for receiving the data of the data source 10 from the antenna 24 via the connection 22 and for passing the data on to the output device 14.

1. A method for charging a battery of a vehicle using a charging station, wherein the charging station comprises:
an electric power source and a data source, wherein an output device which is configured for issuing acoustic signals is arranged in an interior of the vehicle, wherein a first connection for transferring electric power is provided between the power source of the charging station and the battery of the vehicle, wherein a second connection for transferring data is provided between the data source of the charging station and the output device in the vehicle, wherein the electric power is transferred via the first connection from the power source to the battery, and wherein data for acoustic signals is transferred via the second connection from the data source to the output device , wherein the output device issues acoustic signals based on the data received.

2. The method according to claim 1, wherein the acoustic data and/or signals include information on a charging process of the battery.

3. The method according to claim 1, wherein an output device is used which comprises at least one speaker and/or at least one sound source, which is configured to convert and/or transform the data for the acoustic signals into the acoustic signals.

4. The method according to claim 1, wherein the data for the acoustic signals is transferred to the output device via a line as connection for the data and/or via radio, particularly Bluetooth, WLAN, or Wi-Fi, or a mobile phone connection as connection for the data.

5. The method according to claim 1, wherein the electric power is transferred to the battery via a line for electric power and/or by induction.

6. The method according to claim 5, wherein a cable is used which includes the line for the data and the line for electric power.

7. The method according to claim 1, wherein data for visual signals is additionally transferred via the second connection from the data source to the output device.

8. A system for charging a battery of a vehicle, wherein the system comprises:
a charging station and an output device, wherein the charging station comprises an electric power source and a data source, wherein the output device which is configured for issuing acoustic signals must or can be arranged in an interior of the vehicle, wherein a first connection for transferring electric power must or can be provided between the power source of the charging station and the battery of the vehicle, wherein a second connection for transferring data must or can be provided between the data source of the charging station and the output device in the vehicle, wherein the first connection is configured to transfer electric power from the power source to the battery, and wherein the second connection is configured to transfer data for acoustic signals from the data source to the output device, wherein the output device is configured to issue acoustic signals based on the data received.

9. The method according to claim 2, wherein an output device is used which comprises at least one speaker and/or at least one sound source, which is configured to convert and/or transform the data for the acoustic signals into the acoustic signals.

10. The method according to claim 2, wherein the data for the acoustic signals is transferred to the output device via a line as connection for the data and/or via radio, particularly Bluetooth, WLAN, or Wi-Fi, or a mobile phone connection as connection for the data.

11. The method according to claim 3, wherein the data for the acoustic signals is transferred to the output device via a line as connection for the data and/or via radio, particularly Bluetooth, WLAN, or Wi-Fi, or a mobile phone connection as connection for the data.

12. The method according to claim 2, wherein the electric power is transferred to the battery via a line for electric power and/or by induction.

13. The method according to claim 3, wherein the electric power is transferred to the battery via a line for electric power and/or by induction.

14. The method according to claim 4, wherein the electric power is transferred to the battery via a line for electric power and/or by induction.

15. The method according to claim 2, wherein data for visual signals is additionally transferred via the second connection from the data source to the output device.

16. The method according to claim 3, wherein data for visual signals is additionally transferred via the second connection from the data source to the output device.

17. The method according to claim 4, wherein data for visual signals is additionally transferred via the second connection from the data source to the output device.

18. The method according to claim 5, wherein data for visual signals is additionally transferred via the second connection from the data source to the output device.

19. The method according to claim 6, wherein data for visual signals is additionally transferred via the second connection from the data source to the output device.
